(19) United States
(12) Patent Application Publication
(10) Pub. No.: US 2006/0001596 A1
(43) Pub. Date: Jan. 5, 2006

(54) Method and system for displaying holographic images in mobile devices

(75) Inventor: Angelo Cuffaro, Laval (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/881,515

(22) Filed: Jun. 30, 2004

(51) Int. Cl. G09G 3/00

(52) U.S. Cl. 345/32

(57) ABSTRACT

A method and system is disclosed for displaying holographic images in mobile devices. A mobile device in accordance with the present invention comprises a 3D image processing unit and a holographic display unit. The 3D image processing unit generates a holographic image, and the holographic display unit displays the holographic image generated by the 3D image processing unit.

### FIELD OF INVENTION

The present invention is related to a method and system for displaying holographic images in mobile devices.

### BACKGROUND

Currently, mobile devices are typically equipped with a relatively small screen to display texts and images. Mobile devices, such as cellular phones for example, have become smaller and smaller for convenience, portability, and style. Because of the size limitations in mobile devices, only a limited amount of text and images may be displayed on the screen, and the small size with which such text and images (i.e. objects) are displayed often make them difficult to see. This problem is particularly serious for visually impaired people. Further, mobile devices are often configured to receive, over a wired or wired interface, multi-media services, such as video telephone, video conference, mobile internet, multi-media messaging, multi-media game over a wireless or wired interface, or the like. However, the size of the screen of current mobile devices is simply insufficient to adequately display objects associated with such services.

Holographic displays are well known in the art. Generally, holographic displays provide a three dimensional image of an object to replicate an original, complete image of the object. An obstacle in implementing holographic displays has been the large amount of data associated with transmitting/receiving holographic images, the cost of the more-complicated displays that are required, and the impact these issues have on the overall size and weight of a mobile device. However, the inventor has recognized that the amount of data capable of being efficiently exchanged over wireless and wired mediums and the ability of mobile devices to process large amounts of data using newer technologies can make the efficient exchange of holographic images across various data networks a reality. Additionally, the inventor has recognized that the emergence of micro display technology and miniature high-resolution flat panel displays on silicon backplanes can be taken advantage of to reduce the cost of implementing holographic displays.

### SUMMARY

The present invention is related to a method and system for displaying holographic images in mobile devices. A mobile communication device in accordance with the present invention comprises a 3D image processing unit and a holographic display unit. The 3D image processing unit generates a holographic image, and the holographic display unit displays the holographic image generated by the 3D image processing unit.

### BRIEF DESCRIPTION OF THE DRAWINGS

A more detailed understanding of the invention may be had from the following description, given by way of example and to be understood in conjunction with the accompanying drawings wherein:

FIG. 1 is a view of a mobile device in accordance with the present invention;

FIG. 2 is a block diagram of the mobile device shown in FIG. 1; and

FIG. 3 is a flow diagram including steps for displaying holographic images in mobile devices.

### DETAILED DESCRIPTION OF THE PREFERRED EMBODIMENTS

The present invention will be described with reference to the drawing figures wherein like numerals represent like elements throughout. Herein, a mobile communication device (i.e. mobile device) includes but is not limited to a cellular phone, a user equipment, a wireless transmit/receive unit (WTRU), a personal data assistant, a pager, a palm-top computer, a notebook computer, or any other similar type of portable device wherein the device may communicate or otherwise exchange data over a wireless or wired interface. Herein, the terms “holographic image,” “holographic display unit,” and “holographic” may be used interchangeably with “three dimensional (3D),” “three dimensional display (3D) unit,” and “three dimensional (3D),” respectively.

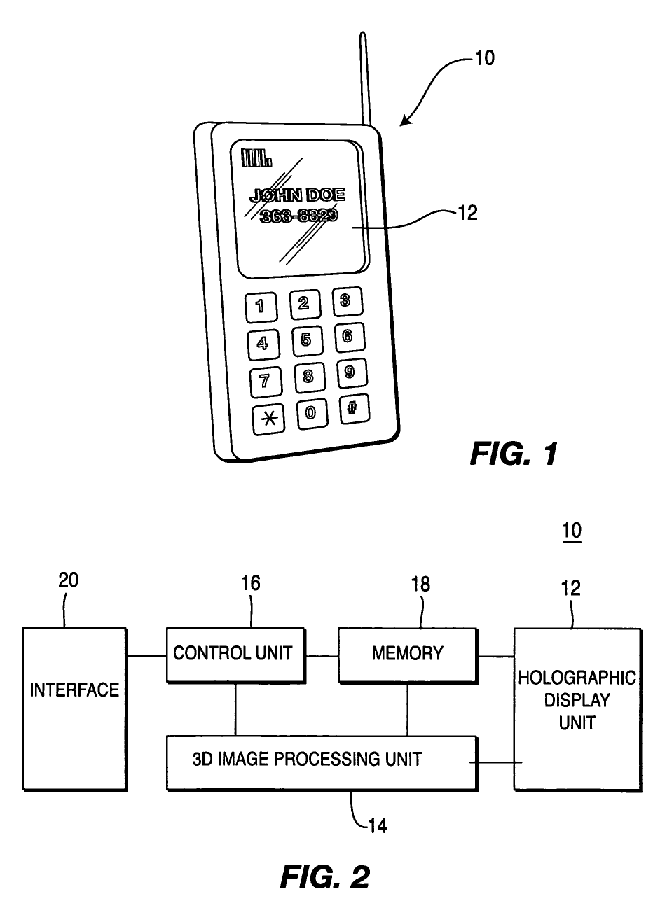

FIG. 1 is a perspective view of a mobile device 10 in accordance with the present invention. A cellular phone type mobile device 10 is depicted purely by the way of example. The configuration of the mobile device 10 of the present invention is similar to currently known mobile devices, but is configured to include a holographic display unit 12 and a 3D image processing unit 14 (shown in FIG. 2). Configuring mobile devices with the ability to provide holographic displays allows images to be displayed in 3D on the holographic display unit 12 of the mobile device 10. Purely by way of example, sample images are shown being displayed in 3D on the holographic display unit 12. Of course, as with any mobile device 10, any type of information, data, or text may be displayed on the holographic display unit 12. By way of example, the information that may be displayed on the holographic display unit 12 includes, but is not limited to, information related to strength of received signals, information related to a power level, a telephone number, a text message, a multimedia message, personal information or memo, a still or animated video image, games, multimedia data, or any information that may be presented to a user in an electronic environment.

Referring now to FIG. 2, a block diagram of the mobile device 10 of FIG. 1 is shown. The mobile device 10 preferably includes a holographic display unit 12, a 3D image processing unit 14, a control unit 16, a memory 18, and an interface 20. In a first preferred embodiment, the mobile device 10 may display holographic images of data (i.e. holographic image data) received in a 3D format (i.e. 3D data). In a second preferred embodiment, the mobile device 10 may display holographic images of data received in a 2D format where additional 3D data is provided or otherwise available to the mobile device 10.

In the first preferred embodiment, the mobile device 10 may receive the 3D data from external resources, such as a multimedia service provider, through the interface 20. For example, if the mobile device 10 receives a video image from a multimedia service provider through the Internet, the multimedia service provider provides 3D data necessary for displaying the video image in 3D format. The mobile device 10 processes the received 3D data to display a 3D image of the video on the holographic display unit 12. The 3D data may be provided through the interface 20 to be processed in real time. Alternatively, the 3D data may be stored in memory 18 of the mobile device 10 and processed at any time.

Regardless of whether 3D data is obtained from the interface 20 or from memory 18, the data is sent to the 3D image processing unit 14 which, in one embodiment, generates a numerical description of an object(s) to be displayed on the holographic display unit 12. The overall operation is controlled by the control unit 16, which may include a single processor or as many processors as desired.

In the second preferred embodiment, 2D data obtained from the interface 20 may be presented in 3D where additional 3D data regarding the 2D data is provided separately over the interface 20 or is otherwise available in memory 18. In a first example, incoming 2D data is alphanumeric in nature and may be, for example, a text message, a document, an email, or any other type of data that may be displayed in some type of alphanumerical format.

In this embodiment, additional 3D data for creating 3D images of alphanumeric data received in 2D format is relatively standard. Therefore, to conserve system resources, alphanumerical data may be transmitted/received over a network in 2D format with the additional 3D data for displaying the data in 3D being transmitted only to users having holographic imaging capability. In this example, alphanumerical data may be transmitted to users as normal in 2D, but users having mobile devices 10 capable of displaying 3D images may be provided an additional data file including appropriate additional 3D data for displaying the 2D data in 3D. In one embodiment, the additional data file preferably includes additional 3D data so that any alphanumeric data received in 2D format may be displayed in 3D. This allows mobile devices to be provided with appropriate additional 3D data for all 2D data with a single transmission thereby reducing network traffic.

To further reduce network traffic, a memory 18 of a mobile device 10 may be configured to include the additional 3D data required for displaying in 3D any alphanumeric data that is received by the mobile device 10 in 2D format. In this case, incoming 2D data received at the interface 20 may be supplemented with appropriate additional 3D data from memory 18 and provided to the 3D image processing unit. This enables standard 2D data received by the mobile device 10 to be displayed in 3D, as desired. For example, if the mobile device 10 receives a call (data or voice) and is required to display caller identification information such as, for example, a telephone number, 3D data of each number to be displayed, which is pre-generated and stored in memory 18, is retrieved from memory 18 and transferred to the 3D image processing unit 14 for reproduction of the numbers in 3D format. This embodiment may be implemented for any type of predefined object.

The second preferred embodiment may also be implemented to provide 3D displays where non-standard objects that cannot, or typically are not, predefined are received in 2D. For example, where some type of multimedia data file is received in 2D format, appropriate 3D data for displaying the multimedia file in 3D may be provided to the mobile device 10 in a separate data file. Alternatively, the appropriate 3D data may be downloaded or otherwise written to memory 18. Regardless of how the mobile device 10 obtains 3D data, the mobile device 10 preferably maintains a 3D data database allowing it to automatically recognize and display in 3D, any received 2D data for which the mobile device 10 possesses appropriate 3D data. This ensures, where it is necessary to utilize system resources for the transmission of 3D data, that any particular mobile device 10 wishing to posses such data only needs to receive the data once, barring any memory failures.

It is noted that the holographic display unit 12 can be any type of display unit configured to display holographic images currently known or developed in the future. By the way of example, a micro display or a conventional spatial light modulator (SLM) may be used as a holographic display. Further, several holographic display technologies that are based on optical micro-electro-mechanical systems (MEMS) have been developed, such as DLP, GLV, IMod, Gyricon, and LCOS. Where micro-display technologies are used, newer optical elements, such as electrically switchable holographic optics may be used to solve display magnification problems without increasing the size and weight of the mobile devices.

The foregoing descriptions are provided by way of example to illustrate embodiments of the present invention. It should be understood that any type of holographic image technology, currently existing or developed in the future, may be utilized, and a specific or particular display method for implementing holographic features in a mobile device is not required.

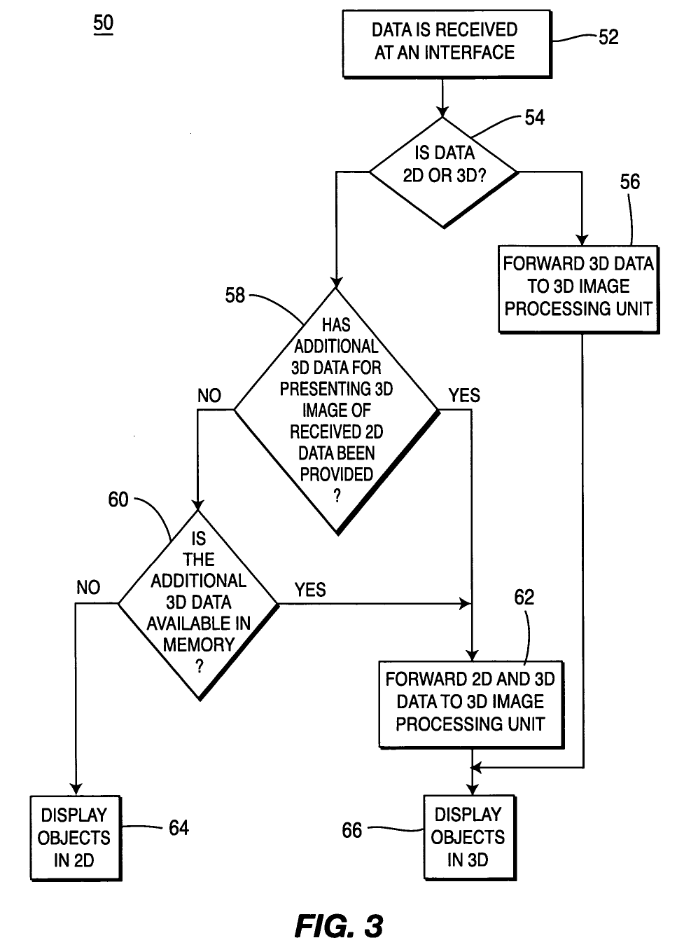

Referring now to FIG. 3, a flow diagram 50 in accordance with the present invention is shown. The diagram 50 begins in step 52 where data is received at an interface of a mobile device. The interface may be any type of interface over which data may be received. For example, the interface may be a wireless interface in a wireless local area network, an infrared interface, a wireless interface for receiving wireless signal in a cellular type wireless network, or any other type of wireless interface. Further, the interface may be any type of wired interface such as a docking station for handheld devices, such as a PDA, or laptops, or any other type of wired interface.

Next, in step 54, it is determined whether the received data is in a 2D format or a 3D format. If it is in a 3D format, the diagram 50 proceeds to step 56 where the 3D data is forwarded to a 3D image processing unit and then to step 66 where the image generated by the 3D image processing unit is displayed in 3D on a display unit of the mobile device.

Referring again to step 54, if the data is in a 2D format, the diagram 50 proceeds to step 58. In step 58, it is determined whether additional 3D data for presenting a 3D image of the objects contained with the received 2D data has been provided. If no additional data has been provided, the diagram proceeds to step 60 where it is determined whether the additional 3D data is available in memory of the mobile device. If the additional 3D data is not available in memory, the objects contained within the 2D data are displayed in 2D (step 64). If the additional 3D data is available in memory, the diagram 50 proceeds to step 62. Referring again to step 58, where the additional 3D data is provided along with the 2D data, the diagram proceeds directly form step 58 to step 62.

In step 62, the 2D and 3D data is forwarded to the 3D image processing unit. Then, the image generated by the 3D image processing unit is displayed on the display unit of the mobile device in 3D.

It is noted that the present invention may be implemented with or without wireless communication capabilities. Although the features and elements of the present invention are described in the preferred embodiments in particular combinations, each feature or element can be used alone without the other features and elements of the preferred embodiments or in various combinations with or without other features and elements of the present invention.

What is claimed is:

1. A mobile communication device comprising:
a communication interface configured to receive holographic image data from an external entity;
a three dimensional (3D) image processing unit configured to generate holographic images of objects to be displayed to a user from holographic image data; and
a holographic display unit configured to display holographic images generated by the 3D image processing unit.

2. The mobile device of claim 1 further comprising a wireless interface configured to communicate with an external entity over the wireless interface.

3. The mobile device of claim 1 further comprising a memory configured to store 3D data of objects to be displayed.

4. The mobile device of claim 1 wherein the holographic display unit comprises a micro-display.

5. The mobile device of claim 4 wherein the micro-display comprises electrically switchable holographic optics.

6. The mobile device of claim 1 wherein the holographic display unit comprises a spatial light modulator (SLM).

7. The mobile device of claim 6 wherein the SLM comprises either a liquid crystal device or an acousto-optic modulator.

8. A mobile communication device comprising:
means for receiving holographic image data from an external entity;
means for generating three dimensional (3D) images of objects to be displayed to a user of the mobile device from holographic image data; and,
means for displaying said 3D images to said user.

9. The mobile device of claim 8 further comprising a wireless interface to communicate with an external entity over the wireless interface.

10. The mobile device of claim 8 further comprising a memory for storing 3D data of objects to be displayed.

11. The mobile device of claim 8 wherein the displaying means comprises a micro-display.

12. The mobile device of claim 11 wherein the micro-display comprises electrically switchable holographic optics.

13. The mobile device of claim 8 wherein the displaying means comprises a spatial light modulator (SLM).

14. The mobile device of claim 13 wherein the SLM comprises either a liquid crystal device or an acousto-optic modulator.

15. A method for displaying holographic image on a mobile device, the method comprising:
receiving data of an object to be displayed;
processing the data in 3D format if 3D data for the object is available; and,
displaying the object on a holographic display unit of the mobile device.

16. The method of claim 15 further comprising:
determining whether the received object data is in 2D format or 3D format;
obtaining 3D data if the received object data is in 2D format.

17. The method of claim 16 wherein the 3D data is obtained from either an external source or internal memory.

18. The method of claim 16 wherein the object is displayed in 2D format if 3D data is not available.
